(19) United States
(12) Patent Application Publication
(10) Pub. No.: US 2012/0239412 A1
(43) Pub. Date: Sep. 20, 2012

(54) METHOD, APPARATUS AND COMPUTER PROGRAM PRODUCT FOR PROVIDING A QUALITY ASSURANCE TOOL FOR PATIENT CARE ENVIRONMENTS

(75) Inventor: Sean Riley, Midlothian, VA (US)

(73) Assignee: McKesson Medical-Surgical Minnesota Supply Inc.

(21) Appl. No.: 13/051,627

(22) Filed: Mar. 18, 2011

(51) Int. Cl. G06Q 50/00

(52) U.S. Cl. 705/2

(57) ABSTRACT

A method for providing a quality assurance tool for patient care environments may include receiving clinical data indicative of incidence of patient conditions within a patient population associated with an organization, receiving organizational usage data indicative of organizational supply usage related to the patient conditions, and providing for generation of a report fusing the clinical data and the organizational usage data. A corresponding computer program product and apparatus are also provided.

### TECHNOLOGICAL FIELD

Embodiments of the present invention relate generally to solutions for providing quality assurance for clinical care and, more particularly, relate to a mechanism for providing a quality assurance tool for patient care environments.

### BACKGROUND

Many aspects of the provision of medical care and the management of many aspects of the healthcare system now involve the use of computers and computer applications. For example, recent efforts have been made to move to electronic medical records (EMR). With clinical documentation systems moving to electronic media, clinical data may be available for incorporation into a number of different applications designed to assist in the management or use of such data. Computerized provider order entry (CPOE) is another example of a development that may improve the ability to electronically access information related to physician's orders. Many other applications are also being developed to utilize electronic information on people and processes to manage the provision of various aspects of patient care.

The use of computer applications is becoming a much more common tool for tracking interactions with patients, for tracking prescriptions, for ordering supplies and for many other clinical care and management tools. However, there is much more to managing care than simply managing record keeping and simplifying ordering or supplies and medications. Behavioral analysis, on an organization wide basis, can also be a useful undertaking.

### BRIEF SUMMARY

A method, apparatus and computer program product are therefore provided to enable the provision of a quality assurance tool that may be used to analyze organization wide behavior relative to medical supply and consumption. Such analysis may be particularly useful in patient care environments such as a long term care environment. Accordingly, for example, some embodiments may enable quality assurance reports to be generated and reviewed regarding utilization of materials employed for patient care.

In one example embodiment, a method for providing a quality assurance tool for patient care environments is provided. The method may include receiving clinical data indicative of incidence of patient conditions within a patient population associated with an organization, receiving organizational usage data indicative of organizational supply usage related to the patient conditions, and providing for generation of a report fusing the clinical data and the organizational usage data.

In another example embodiment, a computer program product for providing a quality assurance tool for patient care environments is provided. The computer program product may include at least one computer-readable storage medium having computer-executable program code instructions stored therein. The computer-executable program code instructions may include program code instructions for receiving clinical data indicative of incidence of patient conditions within a patient population associated with an organization, receiving organizational usage data indicative of organizational supply usage related to the patient conditions, and providing for generation of a report fusing the clinical data and the organizational usage data.

In another example embodiment, an apparatus for providing a quality assurance tool for patient care environments is provided. The apparatus may include processing circuitry. The processing circuitry may be configured for receiving clinical data indicative of incidence of patient conditions within a patient population associated with an organization, receiving organizational usage data indicative of organizational supply usage related to the patient conditions, and providing for generation of a report fusing the clinical data and the organizational usage data.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a block diagram illustrating a system for use in connection with providing a quality assurance tool for patient care environments according to an example embodiment of the present invention;

FIG. 2 is a block diagram showing various components that may be included in an apparatus for providing a quality assurance tool for patient care environments according to an example embodiment of the present invention;

FIG. 3 illustrates an example display in which reports for multiple facilities may be presented together to facilitate utilization comparisons between the facilities according to an example embodiment;

FIG. 4 illustrates an example display in which a report is selectably limited to a specific condition according to an example embodiment;

FIG. 5 illustrates an example of a display showing how the total spend for the organization may be viewed by summing the individual spend of each facility within an enterprise organization according to an example embodiment;

FIG. 6 illustrates an example of a display in which individual items or categories of items may be tracked according to an example embodiment; and

FIG. 7 is a block diagram according to an example method for providing a quality assurance tool for patient care environments according to an example embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As indicated above, some embodiments of the present invention are aimed at providing a mechanism by which to provide a quality assurance tool for long term care environments. As indicated above, ordering of supplies associated with patient care may be handled via electronic or other means. In such situations, if the data regarding supply usage for an organization is input into a database, it could be analyzed to reveal what the usage rates are for the population of an organization. The data may reveal large usages of certain supplies and small usages of other supplies. The data may also reveal trends by enabling data to be reviewed over selectable date ranges. By enabling users to view trends in supply utilization, some issues may be identified and addressed before they become problems.

Electronic information may also be provided regarding clinical data indicative of patient conditions, e.g., diseases or needs. This electronic information may be provided from EMR or from other information provided to the organization such as a minimum data set (MDS) defining information regarding specific health conditions of a patient. The MDS may be gathered at various times during patient treatment such as at patient intake, at various intervals, in response to specific events, and/or at patient discharge. The MDS is also a federally mandated set of data that is to be collected and submitted electronically to the state in which certain healthcare facilities (e.g., nursing homes) reside. Thus, the data can be expected to be reliably available and the set of data topics included therein can be reliably known. By accumulating information about the patient population, it may be possible to examine the various conditions that are present in the patient population.

Some example embodiments may provide a mechanism by which to incorporate the clinical data indicative of patient conditions and the data indicative of supply usage for the organization to identify utilization trends and support quality assurance efforts. For example, one reviewing the information indicative of population wide health conditions may expect a certain amount of supply usage based on those conditions. Example embodiments may provide a tool by which to view usage on a per condition basis. Thus, instead of simply reviewing the cost of certain supplies spread over the entire patient population, it may be further possible to view the cost of certain condition related supplies relative to the number of patients that have the corresponding condition. For example, a population having a large number of patients reporting incontinence may expect to see a relatively high number of incontinence related supplies being used. Seeing instead a fairly low number of incontinence related supplies being used may invite some investigation. Similarly, a population having a low number of patients reporting incontinence, but utilizing large amounts of incontinence-related supplies, may invite some investigation as well. As such, example embodiments may identify situations of over or under utilization of supplies being procured.

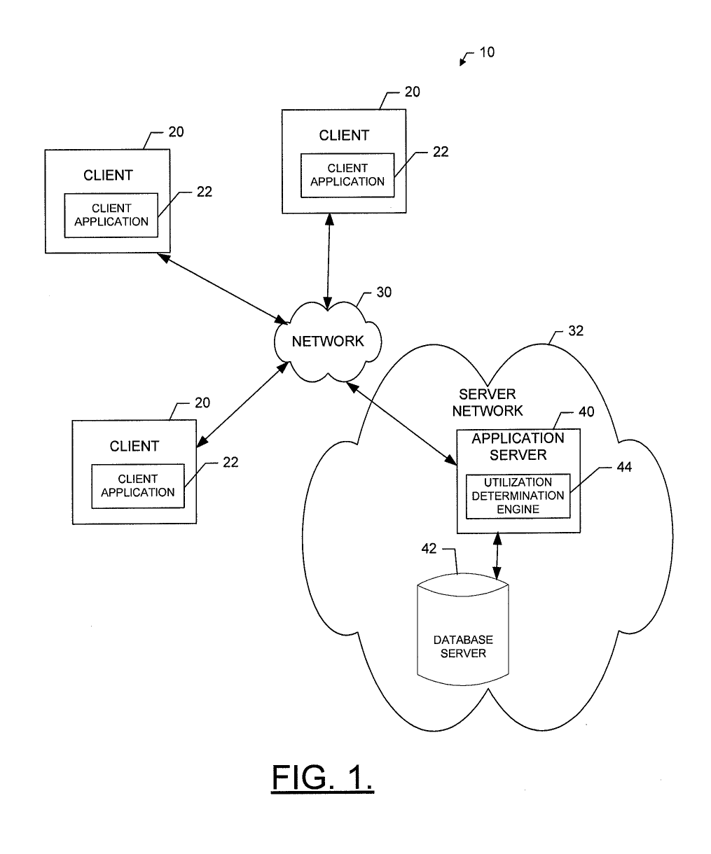

An example embodiment of the invention will now be described in reference to FIG. 1, which illustrates an example system in which an embodiment of the present invention may be employed. As shown in FIG. 1, a system 10 according to an example embodiment may include one or more clients 20 that may, in some cases, be associated with different corresponding healthcare related entities associated with one or more healthcare organizations or systems. For example, one client 20 may be associated with a first facility and a second client 20 may be associated with a second facility. The facilities (and the corresponding clients) may be within the same healthcare organization or system or the facilities could be associated with different healthcare organizations or systems. As such, in some cases, multiple clients may be associated with the same organization, and in other cases each client may be associated with a different organization.

Each client 20 may be, for example, a computer (e.g., a personal computer, laptop computer, network access terminal, or the like) or may be another form of computing device (e.g., a personal digital assistant (PDA), cellular phone, smart phone, or the like) capable of communication with a network 30. As such, for example, each client 20 may include (or otherwise have access to) memory for storing instructions or applications for the performance of various functions and a corresponding processor for executing stored instructions or applications. Each client 20 may also include software and/or corresponding hardware for enabling the performance of the respective functions of the clients as described below. In an example embodiment, one or more of the clients 20 may include a client application 22 configured to operate in accordance with an example embodiment of the present invention. In this regard, for example, the client application 22 may include software for enabling a respective one of the clients 20 to communicate with the network 30 for requesting and/or receiving a utilization determination engine in the form of a deliverable component (e.g., as downloadable software to configure the client, or as a transferable memory device including instructions to configure the client). As such, for example, the client application 22 may include corresponding executable instructions for configuring the client 20 to provide corresponding functionalities as described in greater detail below.

The network 30 may be a data network, such as a local area network (LAN), a metropolitan area network (MAN), a wide area network (WAN) (e.g., the Internet), and/or the like, which may couple the clients 20 to devices such as processing elements (e.g., personal computers, server computers or the like) or databases. Communication between the network 30, the clients 20 and the devices or databases (e.g., servers) to which the clients 20 are coupled may be accomplished by either wireline or wireless communication mechanisms and corresponding protocols.

In an example embodiment, one of the devices to which the clients 20 may be coupled via the network 30 may include one or more application servers (e.g., application server 40), and/or a database server 42, which together may form respective elements of a server network 32. Although the application server 40 and the database server 42 are each referred to as “servers,” this does not necessarily imply that they are embodied on separate servers or devices. As such, for example, a single server or device may include both entities and the database server 42 could merely be represented by a database or group of databases physically located on the same server or device as the application server 40. The application server 40 and the database server 42 may each include hardware and/or software for configuring the application server 40 and the database server 42, respectively, to perform various functions. As such, for example, the application server 40 may include processing logic and memory enabling the application server 40 to access and/or execute stored computer readable instructions for performing various functions. In an example embodiment, one function that may be provided by the application server 40 may be the provision of a utilization determination engine or the provision of services provided by a utilization determination engine of an example embodiment.

In some embodiments, for example, the application server 40 may therefore include an instance of a utilization determination engine 44 comprising stored instructions for handling activities associated with practicing example embodiments as described herein. As such, in some embodiments, the clients 20 may access the utilization determination engine 44 online and utilize the services provided thereby. However, it should be appreciated that in other embodiments, the utilization determination engine 44 may be provided from the application server 40 (e.g., via download over the network 30) to one or more of the clients 20 to enable recipient clients to instantiate an instance of the utilization determination engine 44 for local operation. As yet another example, the utilization determination engine 44 may be instantiated at one or more of the clients 20 responsive to downloading instructions from a removable or transferable memory device carrying instructions for instantiating the utilization determination engine 44 at the corresponding one or more of the clients 20. In such an example, the network 30 may not be needed or utilized at all.

In an example embodiment, the application server 40 may include or have access to memory (e.g., internal memory or the database server 42) for storing instructions or applications for the performance of various functions and a corresponding processor for executing stored instructions or applications. For example, the memory may store an instance of the utilization determination engine 44 configured to operate in accordance with an example embodiment of the present invention. In this regard, for example, the utilization determination engine 44 may include software for enabling the application server 40 to communicate with the network 30 and/or the clients 20 for the provision and/or receipt of information associated with providing quality assurance related analysis of clinical data indicative of patient conditions and data indicative of supply usage (e.g., supply consumption data) for the organization to identify utilization trends and support quality assurance efforts.

As such, the environment of FIG. 1 illustrates an example in which provision of a quality assurance tool for patient care environments may be accomplished by a particular entity (namely the utilization determination engine 44 residing at the application server 40). However, it should be noted that the utilization determination engine 44 could alternatively handle provision of quality assurance services within a single facility. Thus, in some embodiments, the utilization determination engine 44 may be embodied at one or more of the clients 20 and, in such an example, the utilization determination engine 44 may be configured to handle provision of quality assurance services only for the corresponding facility.

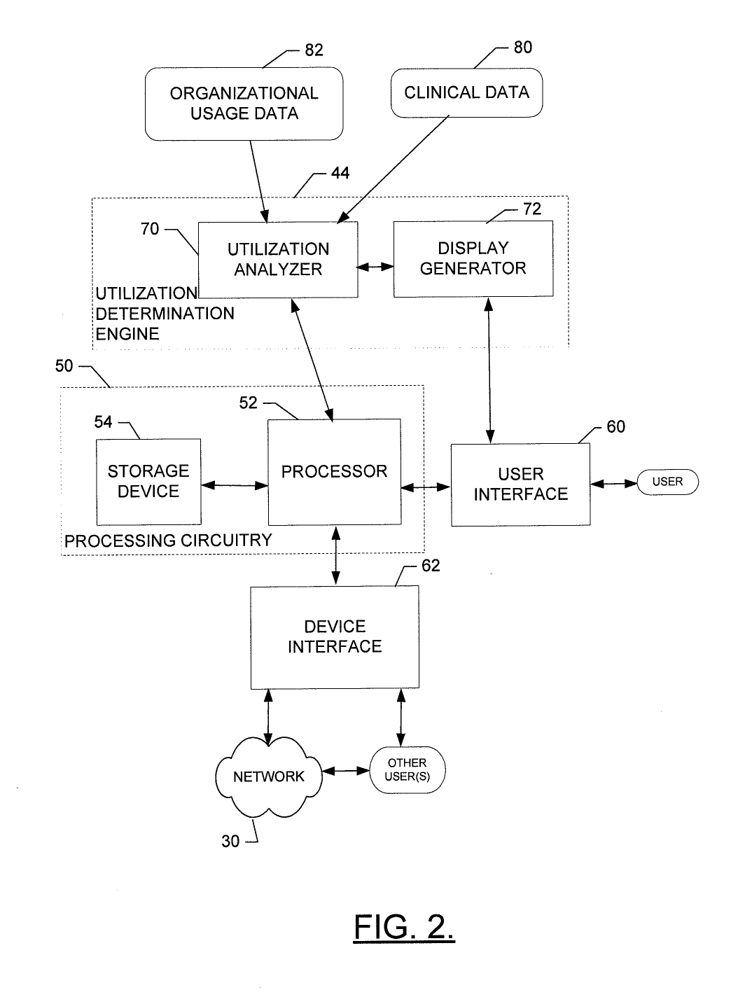

An example embodiment of the invention will now be described with reference to FIG. 2. FIG. 2 shows certain elements of an apparatus for provision of quality assurance services for utilization analysis according to an example embodiment. The apparatus of FIG. 2 may be employed, for example, on a client (e.g., any of the clients 20 of FIG. 1) or a variety of other devices (such as, for example, a network device, server, proxy, or the like (e.g., the application server 40 of FIG. 1)). Alternatively, embodiments may be employed on a combination of devices. Accordingly, some embodiments of the present invention may be embodied wholly at a single device (e.g., the application server 40 or one or more clients 20) or by devices in a client/server relationship (e.g., the application server 40 and one or more clients 20). Furthermore, it should be noted that the devices or elements described below may not be mandatory and thus some may be omitted in certain embodiments.

Referring now to FIG. 2, an apparatus for provision of quality assurance services for utilization analysis is provided. The apparatus may include or otherwise be in communication with processing circuitry 50 that is configured to perform data processing, application execution and other processing and management services according to an example embodiment of the present invention. In one embodiment, the processing circuitry 50 may include a processor 52, a storage device 54 that may be in communication with or otherwise control a user interface 60 and a device interface 62. As such, the processing circuitry 50 may be embodied as a circuit chip (e.g., an integrated circuit chip) configured (e.g., with hardware, software or a combination of hardware and software) to perform operations described herein. However, in some embodiments, the processing circuitry 50 may be embodied as a portion of a server, computer, laptop, workstation or even one of various mobile computing devices. In situations where the processing circuitry 50 is embodied as a server or at a remotely located computing device, the user interface 60 may be disposed at another device (e.g., at a computer terminal or client device such as one of the clients 20) that may be in communication with the processing circuitry 50 via the device interface 62 and/or a network (e.g., network 30).

The user interface 60 may be in communication with the processing circuitry 50 to receive an indication of a user input at the user interface 60 and/or to provide an audible, visual, mechanical or other output to the user. As such, the user interface 60 may include, for example, a keyboard, a mouse, a joystick, a display, a touch screen, a microphone, a speaker, a cell phone, or other input/output mechanisms. In embodiments where the apparatus is embodied at a server or other network entity, the user interface 60 may be limited or even eliminated in some cases.

The device interface 62 may include one or more interface mechanisms for enabling communication with other devices and/or networks. In some cases, the device interface 62 may be any means such as a device or circuitry embodied in either hardware, software, or a combination of hardware and software that is configured to receive and/or transmit data from/to a network and/or any other device or module in communication with the processing circuitry 50. In this regard, the device interface 62 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 62 communicates with a network, the network may be any of various examples of wireless or wired communication networks such as, for example, data networks like a Local Area Network (LAN), a Metropolitan Area Network (MAN), and/or a Wide Area Network (WAN), such as the Internet.

In an example embodiment, the storage device 54 may include one or more non-transitory storage or memory devices such as, for example, volatile and/or non-volatile memory that may be either fixed or removable. The storage device 54 may be configured to store information, data, applications, instructions or the like for enabling the apparatus to carry out various functions in accordance with example embodiments of the present invention. For example, the storage device 54 could be configured to buffer input data for processing by the processor 52. Additionally or alternatively, the storage device 54 could be configured to store instructions for execution by the processor 52. As yet another alternative, the storage device 54 may include one of a plurality of databases (e.g., database server 42) that may store a variety of files, contents or data sets. Among the contents of the storage device 54, applications (e.g., client application 22 or utilization determination engine 44) may be stored for execution by the processor 52 in order to carry out the functionality associated with each respective application.

The processor 52 may be embodied in a number of different ways. For example, the processor 52 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processor 52 may be configured to execute instructions stored in the storage device 54 or otherwise accessible to the processor 52. As such, whether configured by hardware or software methods, or by a combination thereof, the processor 52 may represent an entity (e.g., physically embodied in circuitry) capable of performing operations according to embodiments of the present invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor 52 to perform the operations described herein.

In an example embodiment, the processor 52 (or the processing circuitry 50) may be embodied as, include or otherwise control the utilization determination engine 44, which may include or otherwise control a utilization analyzer 70 and a display generator 72. The utilization analyzer 70 and the display generator 72 may be any means such as a device or circuitry operating in accordance with software or otherwise embodied in hardware or a combination of hardware and software (e.g., processor 52 operating under software control, the processor 52 embodied as an ASIC or FPGA specifically configured to perform the operations described herein, or a combination thereof) thereby configuring the device or circuitry to perform the corresponding functions of the utilization analyzer 70 and display generator 72, respectively, as described below.

The utilization analyzer 70 may be configured to receive clinical data 80 indicative of patient conditions (e.g., diagnosed diseases, recurring symptoms, activity and/or food requirements, health care supply requirements, etc.) and organizational usage data 82 (e.g., data indicative of supply usage for the organization). In an example embodiment, the clinical data 80 may be received from MDS data generated at patient intake, in response to specific events, at defined intervals and/or at patient discharge. As an alternative to using MDS data, some embodiments may use EMR data or even data from questionnaires or other sources. The organizational usage data 82 may be provided from another application (e.g., a supply ordering and/or management application) or may be extracted from reports (e.g., spreadsheets, order forms and/or the like) provided with consumption and/or supply ordering information. The organizational usage data 82 may be limited to supplies used for patient care (e.g., supplies used by residents of a long term care facility).

The utilization analyzer 70 may be configured to analyze and/or compare the clinical data 80 and the organizational usage data 82 to determine the health status of patients relative to the products used by the patients. Moreover, the utilization analyzer 70 may enable a user to generate reports showing various aspects of the analysis. For example, the user may be enabled to select specific report periods, specific supplies or supply types, specific patient conditions, and/or the like to generate highly configurable reports that provide a view of relevant information for the user. The ability to automatically generate highly configurable reports may enable the user to identify utilization trends and support quality assurance efforts for the organization. For example, since specific patient conditions may be identified for reporting purposes, patients having a specific condition may be isolated with respect to the consumption materials that may be directly related to the isolated condition. Using the example described above, the use of products related to incontinence may be reviewed in a report generated to isolate usage of specific products related to incontinence against the segment of the patient population that has reported incontinence as a health condition. As such, the utilization analyzer 70 may enable the organization to isolate and identify their costs relative to a specific segment of the patient population rather than across the entire patient population. Thus, although patient day rate information may be provided (e.g., via reports generated on a per patient day (PPD) basis), example embodiments may further provide segmented patient day rate information based on specifically isolable patient segments (e.g., via reports generated on a per condition day (PCD) basis). PCD refers to the ability to view product consumption/spend per associated clinical day (e.g., diabetic glucose strip consumption per diabetic patient day).

In some cases, the utilization analyzer 70 may be configured to generate utilization reports indicating the actual utilization for the organization based on the clinical data 80 and organizational usage data 82. However, the utilization analyzer 70 may also be configured to receive data indicative of expected utilization rates to enable comparison of actual utilization to expected utilization. The expected utilization rate data may be provided based on patient data combined with information provided from standards organizations. Thus, for example, expected utilization for nursing home patients may be calculated based on a mixture of nursing home patient census data and national nursing standards. Thus, since patients with different acuity require different amounts of product, combining patient acuity data, from the patient census data, with national standards may enable an expected value to be determined. However, other methods of determining expected values may also be used. By using the ability to compare actual and expected utilization rates, the utilization analyzer 70 may be configured to enable the organization to perform benchmarking to determine whether their utilization protocols should be modified or corrected. Accordingly, quality assurance may be provided with respect to care provided by an organization.

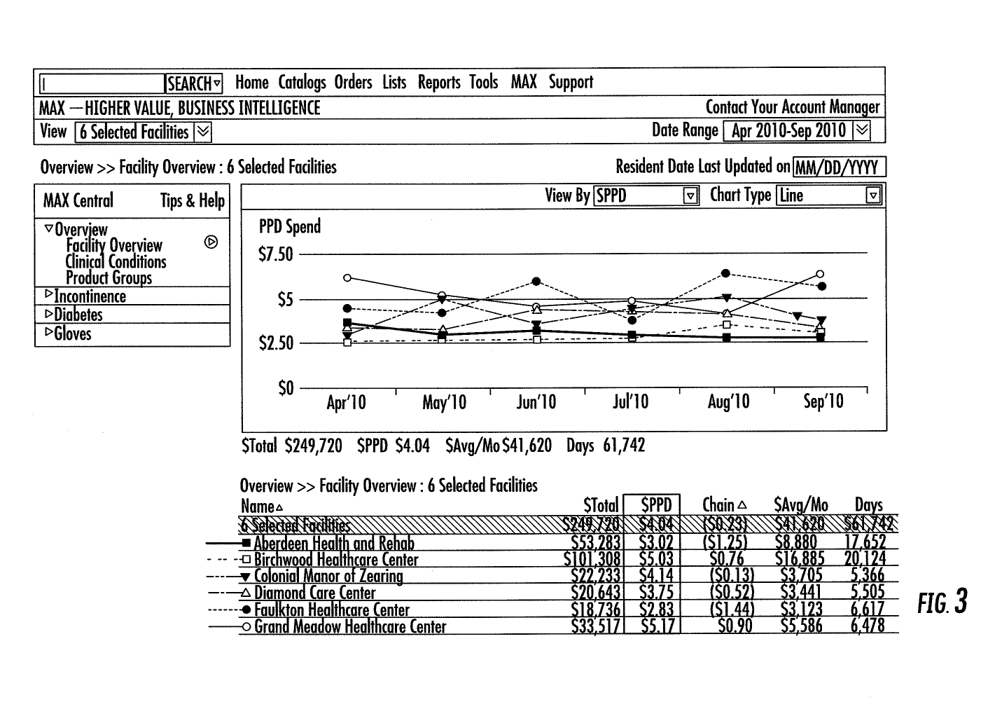

The utilization analyzer 70 may provide data corresponding to the selections made by the user to the display generator 72. The display generator 72 may be configured to generate user interface elements for rendering of reports, charts, bar graphs, pie graphs or other visual content to illustrate utilization analysis results determined by the utilization analyzer 70. As such, in some cases, the display generator 72 may be configured to provide selectable options with regard to the features to be displayed and the manner in which to display the features. In some cases, the selectable options may include options for selecting multiple facilities over which data may be reported. For example, the facilities may be individual facilities within a single organization (e.g., an enterprise organization). However, in some cases, the facilities may themselves be separate organizations. FIG. 3 illustrates an example in which reports for six facilities may be presented together to facilitate utilization comparisons between the facilities. In some cases, the facilities to be displayed may be selected from a drop down menu illustrating the facilities for which data is available, and therefore also for which reports may be generated.

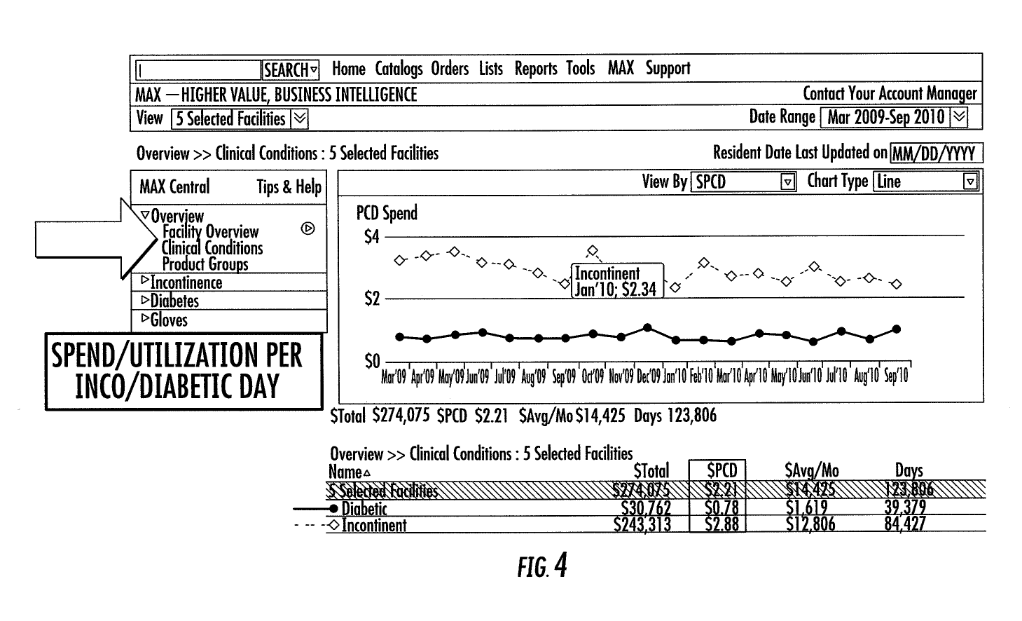

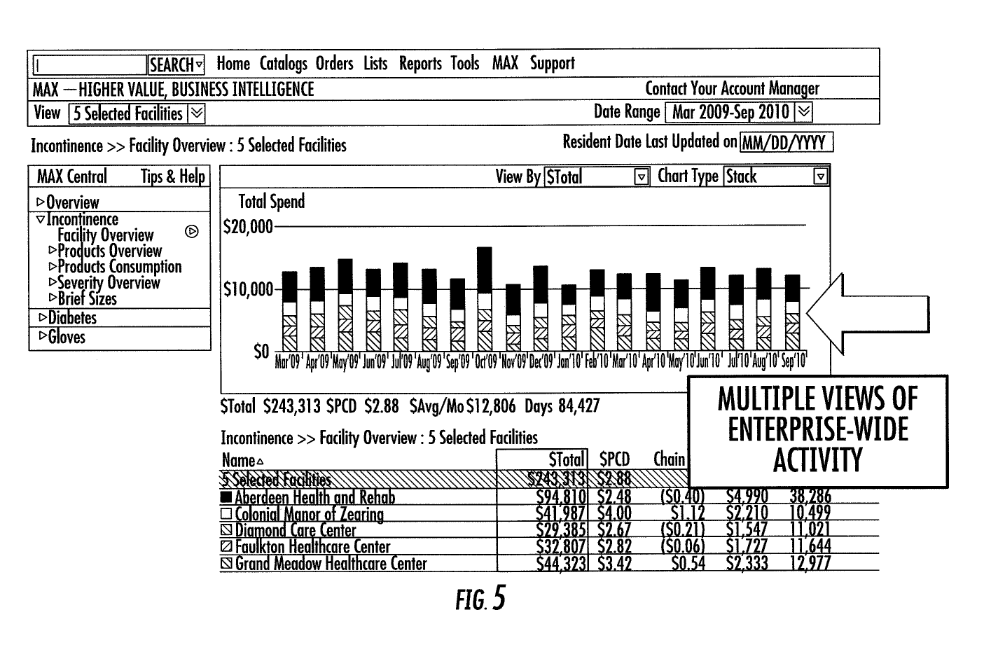

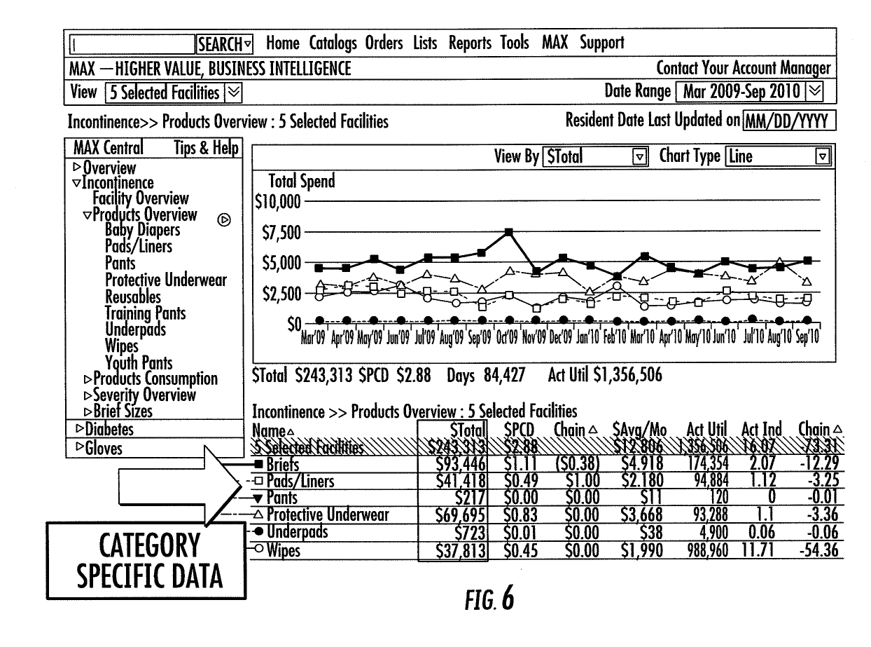

As shown in FIG. 4, the reports may also be limited to a specific condition. Thus, for example, a specific condition may be selected and utilization on a PCD basis may be displayed. FIG. 5 illustrates how the total spend for the organization may be viewed by summing the individual spend of each facility within an enterprise organization. FIG. 6 illustrates an example in which individual items or categories of items may be tracked. As indicated above, any of the reports may be provided over selectable date ranges to enable users to conduct trend analysis by viewing utilization information over the selectable date ranges (e.g., last 24 months, last year, etc.). Some example embodiments may also incorporate an ability to benchmark individual organizational data against similar organizations situated in the same region, state, or country. Some embodiments may also incorporate information regarding reimbursable services so that reimbursed supply consumption may also be evaluated. This may provide financial benefits by reflecting a lower, more accurate supply spend. Some example embodiments may incorporate information regarding reimbursed medication supply services so that an accurate view of the number or amount of supplies being used for certain conditions may be evaluated. Some embodiments may also integrate data feeds from vendors (e.g., pharmacies or therapy providers) so that external resource consumption may also be evaluated.

Accordingly, example embodiments may enable patient level spend and utilization to be displayed and trends to be analyzed. Moreover, using clinical data to inform the system about the expected needs of the organization based on the health conditions reported in the patient population, it may be possible to analyze utilization on a per condition basis and/or a per patient basis. Thus, deeper and more useful trend analysis may be possible so that treatment protocols and supply management processes may be improved.

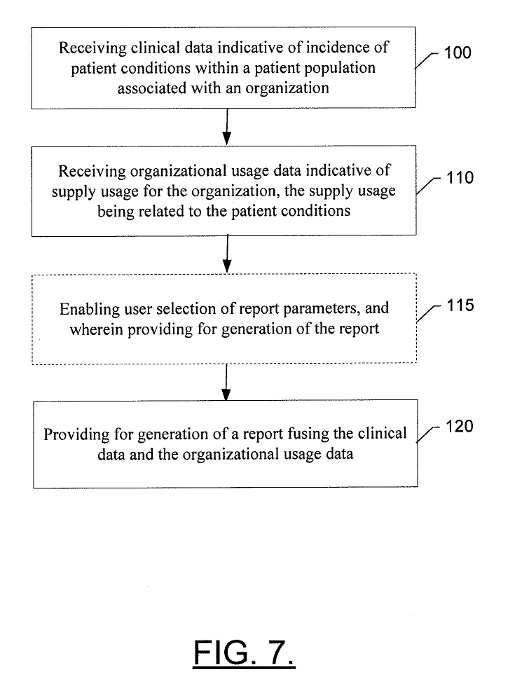

Embodiments of the present invention may therefore be practiced using an apparatus such as the one depicted in FIG. 2. However, other embodiments may be practiced in connection with a computer program product for performing embodiments of the present invention. FIG. 7 is a flowchart of a method and program product according to example embodiments of the invention. Each block or step of the flowchart of FIG. 7, and combinations of blocks in the flowchart, may be implemented by various means, such as hardware, firmware, processor, circuitry and/or another device associated with execution of software including one or more computer program instructions. Thus, for example, one or more of the procedures described above may be embodied by computer program instructions, which may embody the procedures described above and may be stored by a storage device (e.g., storage device 54) and executed by processing circuitry (e.g., processor 52).

As will be appreciated, any such stored computer program instructions may be loaded onto a computer or other programmable apparatus (i.e., hardware) to produce a machine, such that the instructions which execute on the computer or other programmable apparatus implement the functions specified in the flowchart block(s). These computer program instructions may also be stored in a non-transitory computer-readable storage medium comprising memory that may direct a computer or other programmable apparatus to function in a particular manner, such that the instructions stored in the computer-readable memory produce an article of manufacture including instructions to implement the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

In this regard, a method according to one embodiment of the invention, as shown in FIG. 7, may include receiving clinical data indicative of incidence of patient conditions within a patient population associated with an organization at operation 100, receiving organizational usage data indicative of organizational supply usage related to the patient conditions at operation 110, and providing for generation of a report (e.g., printed or displayed on an electronic display (e.g., a dashboard display)) fusing the clinical data and the organizational usage data at operation 120.

In some cases, the method may include additional optional operations (an example of which is shown in dashed lines in FIG. 7). Any additional operations, and/or modifications to the operations above or the additional operations, may be performed in addition to the operations described above in any order and in any combination. Thus, in some embodiments, all of the additional operations or modifications may be practiced, while in others none of the additional operations or modifications may be practiced. In still other embodiments, any combination of less than all of the additional operations or modifications may be practiced. In an example embodiment, the method may further include enabling user selection of report parameters at operation 115. In such an example, providing for generation of the report may include providing for generation of the report fusing the clinical data and the organizational data based on the report parameters selected. In some example embodiments, providing for generation of the report may include providing for generation of the report displaying organizational usage on a per condition day basis. In an example embodiment, enabling user selection of report parameters may include enabling user selection of multiple facilities for which corresponding clinical data and organizational usage data is analyzed. In some embodiments, enabling user selection of report parameters may include enabling user selection of one or more condition-based patient segments over which corresponding clinical data and organizational usage data is analyzed. In some cases, enabling user selection of report parameters may include enabling user selection of one or more supplies with respect to which corresponding clinical data and organizational usage data is analyzed. In an example embodiment, providing for generation of the report may include providing for generation of the report displaying usage trends for utilization analysis. Other modifications are also possible. The modifications and optional operations may be included in any combination and in any order with respect to the operations 100-120 described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving clinical data indicative of incidence of patient conditions within a patient population associated with an organization;
receiving organizational usage data indicative of supply usage for the organization, the supply usage being related to the patient conditions; and
providing for generation of a report fusing the clinical data and the organizational usage data.

2. The method of claim 1, wherein providing for generation of the report comprises providing for generation of the report displaying organizational usage on a per condition day basis.

3. The method of claim 1, further comprising enabling user selection of report parameters, and wherein providing for generation of the report comprises providing for generation of the report fusing the clinical data and the organizational data based on the report parameters selected.

4. The method of claim 3, wherein enabling user selection of report parameters comprises enabling user selection of multiple facilities for which corresponding clinical data and organizational usage data is analyzed.

5. The method of claim 3, wherein enabling user selection of report parameters comprises enabling user selection of one or more condition-based patient segments over which corresponding clinical data and organizational usage data is analyzed.

6. The method of claim 3, wherein enabling user selection of report parameters comprises enabling user selection of one or more supplies with respect to which corresponding clinical data and organizational usage data is analyzed.

7. The method of claim 1, wherein providing for generation of the report comprises providing for generation of the report displaying usage trends for utilization analysis.

8. An apparatus comprising processing circuitry configured to:
receive clinical data indicative of incidence of patient conditions within a patient population associated with an organization;
receive organizational usage data indicative of supply usage for the organization, the supply usage being related to the patient conditions; and
provide for generation of a report fusing the clinical data and the organizational usage data.

9. The apparatus of claim 8, wherein the processing circuitry being configured to provide for generation of the report comprises the processing circuitry being configured to provide for generation of the report displaying organizational usage on a per condition day basis.

10. The apparatus of claim 8, wherein the processing circuitry is further configured to enable user selection of report parameters, and wherein providing for generation of the report comprises providing for generation of the report fusing the clinical data and the organizational data based on the report parameters selected.

11. The apparatus of claim 10, wherein the processing circuitry being configured to enable user selection of report parameters comprises the processing circuitry being configured to enable user selection of multiple facilities for which corresponding clinical data and organizational usage data is analyzed.

12. The apparatus of claim 10, wherein the processing circuitry being configured to enable user selection of report parameters comprises the processing circuitry being configured to enable user selection of one or more condition-based patient segments over which corresponding clinical data and organizational usage data is analyzed.

13. The apparatus of claim 10, wherein the processing circuitry being configured to enable user selection of report parameters comprises the processing circuitry being configured to enable user selection of one or more supplies with respect to which corresponding clinical data and organizational usage data is analyzed.

14. The apparatus of claim 8, wherein the processing circuitry being configured to provide for generation of the report comprises the processing circuitry being configured to provide for generation of the report displaying usage trends for utilization analysis.

15. A computer program product comprising at least one computer-readable storage medium having computer-executable program code instructions stored therein, the computer-executable program code instructions comprising program code instructions for:
receiving clinical data indicative of incidence of patient conditions within a patient population associated with an organization;
receiving organizational usage data indicative of supply usage for the organization, the supply usage being related to the patient conditions; and
providing for generation of a report fusing the clinical data and the organizational usage data.

16. The computer program product of claim 15, wherein program code instructions for providing for generation of the report include instructions for providing for generation of the report displaying organizational usage on a per condition day basis.

17. The computer program product of claim 15, further comprising program code instructions for enabling user selection of report parameters, and wherein program code instructions for providing for generation of the report include instructions for providing for generation of the report fusing the clinical data and the organizational data based on the report parameters selected.

18. The computer program product of claim 17, wherein program code instructions for enabling user selection of report parameters include instructions for enabling user selection of multiple facilities for which corresponding clinical data and organizational usage data is analyzed.

19. The computer program product of claim 17, wherein program code instructions for enabling user selection of report parameters include instructions for enabling user selection of one or more condition-based patient segments over which corresponding clinical data and organizational usage data is analyzed.

20. The computer program product of claim 17, wherein program code instructions for enabling user selection of report parameters include instructions for enabling user selection of one or more supplies with respect to which corresponding clinical data and organizational usage data is analyzed.

21. The computer program product of claim 15, wherein program code instructions for providing for generation of the report include instructions for providing for generation of the report displaying usage trends for utilization analysis.
